(19) United States
(12) Patent Application Publication
(10) Pub. No.: US 2005/0108722 A1
(43) Pub. Date: May 19, 2005

(54) Systems and methods for external service administration

(76) Inventors: Thomas Salomon, Rauenberg (DE); Wolfgang Ambrosch, Friedrichshafen (DE); Kristian Mitic, Ravensburg (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/953,521

(22) Filed: Sep. 30, 2004

Related U.S. Application Data
(60) Provisional application No. 60/507,129, filed on Oct. 1, 2003.

(51) Int. Cl. G06F 9/00

(52) U.S. Cl. 719/310

(57) ABSTRACT

Systems and methods are provided for externally administrating local services, such as Windows-based services. The external administration of the local services may be performed with at least one centrally installed service administration program. To enable central administration of local services, the services may be installed on one or more computers, and a service management program administrating the services locally may be installed on the computers, respectively. Further, the service administration program may communicate administration information with the service management program to administrate the services, respectively, and the service administration program may provide a single graphical user interface to administrate the local services through the service management program.

### CROSS-REFERENCE TO RELATED APPLICATION(S)

This application claims the benefit of priority of U.S. Provisional Patent Application No. 60/507,129, filed Oct. 1, 2003, the disclosure of which is expressly incorporated herein by reference to its entirety.

### BACKGROUND

1. Field of the Invention

The present invention generally relates to systems and methods for externally administrating local services, such as Windows-based services. The external administration may be performed with at least one centrally installed service administration program, or with local computers and a central computer. The invention also relates to computer programs and computer program products for externally administrating local services, such as Windows-based services. Moreover, the invention relates to displays for showing the external administration of local services.

2. Background Information

In common applications, such as Environment, Health and Safety (EH&S) within a SAP R/3 system, services like Word for Windows Integrator (WWI), Ehsstart.exe and EXPERT services are installed as Windows-based services, running on local computers. These services are defined by a program ID and may register as a server within an external R/3 application program.

The WWI service provides integrating templates into Word for Windows, and these templates are filled with actual production data. This service also provides printing labels according to the templates and production data. The WWI service has to be installed locally, as Microsoft Word requires a local installation for using its functionality.

Besides the services WWI and EXPERT, the service Ehsstart.exe may run on each computer locally. This service monitors the WWI and EXPERT services. In case of malfunction of these services, the Ehsstart.exe services may restart the respective services, automatically.

As the services previously described are installed on local computers, they have to be administrated locally on the respective computers. A remote access to the services is not possible using a single user interface. In particular, when using a central application, not running on a Windows platform, the administration of the local services is not possible. Integrating local administration into an Enterprise Resource Planning (ERP) system, such as SAP R/3, would allow faster and easier administration of the services.

Furthermore, a local installation effort might be reduced. A major drawback of current systems is that a system administrator has to configure, administrate and maintain all services running within Windows computers locally, and manually. The system administrator cannot access these services from a central computer which, for instance, runs on a different operating system.

### SUMMARY OF THE INVENTION

Embodiments consistent with present invention may provide for the installation of services on computers. In one embodiment, a service management program administrating the services locally is installed on the computers, respectively. A service administration program may communicate administration information using remote function call messages with the service management program to administrate the services, respectively. Further, the service administration program may provide a single graphical user interface to administrate the local services through the service management program.

By providing a local service management program, configured to receive and send remote function calls, the local services may be administrated through a single service management program. The service management program might also run as a service on the local computers. The local service management program service may be set to start automatically, so that it runs as soon as the operating system is booted. The service management program may communicate with the service administration program using remote function calls. The remote function call messages may be from a set of pre-defined messages of an SAP R/3 system or may be defined according to the needs of administration. The central service administration program may, for instance, run on an SAP R/3 system. By using remote function call messages, commands may be received by the service management program from the central administration program, functions may be executed accordingly, and a status of the services or the result of the functions may be sent back to the central administration program. To allow a plurality of administration and maintenance functions, the remote function call (RFC) messages may be extended by additional messages, which are designed for functions, as further set out below.

To allow easy administration of the service management programs and, thus, administration of the local services, embodiments of the invention may provide for the use of a single graphical user interface, through which the services may be administrated. A user may select certain services within the graphical user interface and then check their functionality or administrate their parameters.

To provide unified messaging, embodiments of the invention may enable communication between the service administration program and the service management program by transmitting remote function call messages through a single communication gateway. A user interface may be implemented within R/3 and enable communication with external services, such as WWI and EXPERT, via a single communication gateway. The remote function call messages may be understood as a message format as known by certain SAP products. The usual RFC messages may be extended by additional RFC messages to support the inventive functions disclosed herein.

To allow identification of different service management programs within the service administration program and the graphical user interface, embodiments of the invention may provide for registering the service management program at the communication gateway using a program ID, identifying the service management program within the single graphical user interface and using the program ID by the service administration program. The program ID may be a unique identifier for each service management program. By using this unique identifier, a service management program may be identified within the single graphical user interface. This identifier may enable communicating with a particular service management program in case more than one service management program is registered and available through the single graphical user interface.

Each external computer may comprise only one service management program. Via remote function call parameters and program IDs, this service management program may be registered at the service administration program using its program ID. Communication with these service management programs may then be carried out using this program ID.

According to another embodiment, the single communication gateway provides communication with the service management program for a plurality of service administration programs connected with the communication gateway. It is possible to communicate with a plurality of service management programs, which reside on different external computers, using one single gateway. Also, a plurality of service administration programs may access one service management program, enabling administration from various different systems.

The single communication gateway may provide access to a plurality of service management programs, respectively, from one service administrating program and one graphical user interface. For instance, WWI and EXPERT services running on, for instance, client computers might both be administrated at the same time using one single gateway and one single administration program within an SAP R/3 system.

To allow for the registration of a service management program on various SAP R/3 systems, which each comprise service administration programs, each service management program may provide its remote function call (RFC) parameters to the respective service administration program. Further, each service management program may store information about a service administration program in a file, such as saprfc.ini. Each service management program may change their service configuration according to the service administration program destination retrieved from the service administration program by RFC parameters and initiate the creation of a new program thread of a service management program for each service administration program, respectively.

According to another embodiment, the service management program may run in multiple threads, each thread communicating with a different service administration program through the remote function calls. TCP/IP destinations may be established and a port on the communication gateway iprovided for communicating with the respective service management program.

To avoid interference of different service administration programs administrating local services through a single service management program at one time, embodiments of the invention may provide for the synchronization of the service management threads so that messages from different service administration programs do not interfere during administration of the services.

To allow administrating certain services within the local computers, the service management program may provide a list of services installed on the local computers to the service administration program and the services may be presented and administrated through the single graphical user interface. This list may be used to access the respective service on the respective computer. As more than one service may be installed locally, these services might have to be administrated independently. The list may provide a unique identifier for each service, by which this service may be addressed.

To allow installing and de-installing, or starting and stopping certain services, the service administration program may send install, or start/stop messages to the service management program to install and/or de-install, start, and/or stop the services locally.

In accordance with yet another embodiment, services within a Windows operating system may generate service control messages informing about their status, warnings, and errors. To get centrally knowledge of this information, the service management program may send service control messages comprising service control information of the services to the service administration program, and the service administration program may present the service control information through the single graphical user interface. The service administrator, thus, may receive knowledge centrally about the status of the local services. The service may then be administrated according to the present status.

Another embodiment may provide for dividing the service control information into one or more categories, such as service status information, service warning information and/or service error information. The service control information may be presented through a single graphical user interface in a different way according to its category.

To allow for the configuring of services, which may be configured by service configuration parameters, the service management program may send service configuration parameter messages comprising configuration parameters of the services to the service administration program, and the service administration program may present the configuration parameters through the single graphical user interface. The present configuration of a service may be monitored centrally.

To allow for monitoring and configuring one or more configuration parameters, the service administration program may store the configuration parameters and enable editing of the services with the configuration parameters through a single graphical user interface. The service parameters, once edited, may then be sent to one or more respective service management programs, which edit the service configuration parameters locally and administrate the respective services.

To get central knowledge about the usage of each service from the central computer, the service management program may send service statistic messages comprising statistics of the services to the service administration program, and the service administration program may present the statistics through the single graphical user interface.

Consistent with another embodiment of the invention, the statistics may comprise information about, for example, a number of accesses to the services, operating hours of the services, and idle times of the services. From the knowledge about idle times and busy times of the services, the workload of the services may be calculated.

To enable installation and administration of services from an external computer using the service management programs, the service management program may be provided with local administration rights for local service administration. By providing the service management program with administration rights, the program may install, de-install and configure services and their parameters locally. The operating system allows these changes to its files only, in case the service management program has administration rights.

During the installation of the service management program locally, a local operation account of the service management program may be acquired and the local operating account may be provided with administration rights for local service administration. According to this embodiment, the service management program may also be provided with administration rights.

There may be further provided a computer system comprising a central administration computer and a local service computer operating services locally, in particular Windows-based services, the local computer comprises service means operating the services, the local computer comprises management means operating a service management to administrate the services locally, respectively, the central computer comprises administration means operating the service administration and communicating administration information with the service means to administrate the services, respectively, and the central computer comprises display means displaying a single graphical user interface to administrate the local services through the service means.

There may be further provided a computer program for externally administrating local services, in particular Windows-based services, with at least one centrally installed service administration program with instructions operable to cause a processor to install the services on computers, administrate the services locally with a service management program installed on the computers, respectively, communicate administration information between the service administration program and the service management program to administrate the services, respectively and provide a single graphical user interface within the service administration program to administrate the local services through the service management program graphically.

There may be further provided a computer program product for externally administrating local services, in particular Windows-based services, with at least one centrally installed service administration program with a computer program stored thereon with instructions operable to cause a processor to install the services on computers, administrate the services locally with a service management program installed on the computers, respectively, communicate administration information between the service administration program and the service management program to administrate the services, respectively and provide a single graphical user interface within the service administration program to administrate the local services through the service management program graphically.

There may be further provided a display for showing external administration of local services, in particular Windows-based services, on at least one centrally installed service administration program. The display may show administration information to administrate local services through service management programs with locally installed services using a service management program administrating the services locally. The service administration program may communicate administration information with the service management program to administrate the services, respectively.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed. Other embodiments and features may be provided within the scope of the present invention.

### BRIEF DESCRIPTION OF THE DRAWINGS

Referring now to the drawings, in which like numerals represent like elements throughout the several figures, aspects of the present invention and the exemplary operating environment will be described. In the drawings show:

FIG. 1 illustrates an exemplary computer system, consistent with an embodiment of the present invention;

FIG. 2 illustrates an exemplary system with administration computer and service computers, consistent with an embodiment of the present invention;

FIG. 3 illustrates a flowchart of an exemplary method, consistent with an embodiment of the present invention;

FIG. 4 illustrates a first screenshot of an exemplary program, consistent with an embodiment of the present invention;

FIG. 5 illustrates a second screenshot of an exemplary program, consistent with an embodiment of the present invention;

FIG. 6 illustrates a third screenshot of an exemplary program, consistent with an embodiment of the present invention; and

FIG. 7 illustrates a fourth screenshot of an exemplary program, consistent with an embodiment of the present invention.

### DESCRIPTION OF THE EMBODIMENTS

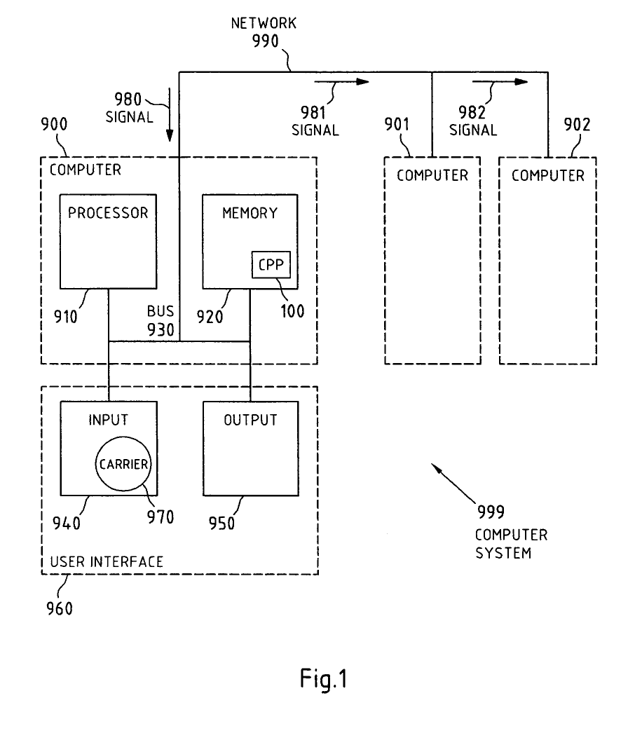

FIG. 1 illustrates a simplified block diagram of exemplary computer system 999 having a plurality of computers 900, 901, 902 (or even more).

Computer 900 can communicate with computers 901 and 902 over network 990. Computer 900 includes processor 910, memory 920, bus 930, and, optionally, input device 940 and output device 950 (I/O devices, user interface 960). As illustrated, embodiments of the invention may be implemented by computer program product 100 (CPP), carrier 970 and/or signal 980.

With respect to computer 900, computer 901/902 may be referred to as a “remote computer.” Computer 901/902 is, for example, a server, a peer device or other common network node, and typically has many or all of the elements described relative to computer 900.

Computer 900 is, for example, a conventional personal computer (PC), a desktop device or a hand-held device, a multiprocessor computer, a pen computer, a microprocessor-based or programmable consumer electronics device, a minicomputer, a mainframe computer, a personal mobile computing device, a mobile phone, a portable or stationary personal computer, a palmtop computer or the like.

Processor 910 is, for example, a central processing unit (CPU), a micro-controller unit (MCU), digital signal processor (DSP), or the like.

Memory 920 may comprise elements that temporarily or permanently store data and instructions. Although memory 920 is illustrated as part of computer 900, memory can also be implemented in network 990, in computers 901/902 and in processor 910 itself (e.g., cache, register), or elsewhere. Memory 920 can be a read only memory (ROM), a random access memory (RAM), or a memory with other access options. Memory 920 may be physically implemented by computer-readable media, for example: (a) magnetic media, like a hard disk, a floppy disk, or other magnetic disk, a tape, a cassette tape; (b) optical media, like optical disk (CD-ROM, digital versatile disk (DVD), etc.); and (c) semiconductor media, like DRAM, SRAM, EPROM, EEPROM, memory stick.

Optionally, memory 920 is distributed. Portions of memory 920 can be removable or non-removable. For reading from media and for writing in media, computer 900 may use well-known devices, for example, disk drives, or tape drives.

Memory 920 stores modules such as, for example, a basic input output system (BIOS), an operating system (OS), a program library, a compiler, an interpreter, and a text-processing tool. Modules are commercially available and can be installed on computer 900. For simplicity, these modules are not illustrated.

CPP 100 has program instructions and, optionally, data that cause processor 910 to execute method steps consistent with embodiments of the present invention. In other words, CPP 100 can control the operation of computer 900 and its interaction in network system 999 so that is operates to perform in accordance with embodiments of the invention. For example and without the intention to be limiting, CPP 100 can be available as source code in any programming language, and as object code (“binary code”) in a compiled form.

Although CPP 100 is illustrated as being stored in memory 920, CPP 100 can be located elsewhere. CPP 100 can also be embodied in carrier 970.

In FIG. 1, carrier 970 is illustrated outside computer 900. For communicating CPP 100 to computer 900, carrier 970 may be conveniently inserted into input device 940. Carrier 970 is implemented as any computer readable medium, such as a medium largely explained above (cf. memory 920). Generally, carrier 970 is an article of manufacture having a computer readable medium with computer readable program code to cause the computer to perform methods consistent with embodiments of the present invention. Further, signal 980 can also embody computer program product 100.

Having described CPP 100, carrier 970, and signal 980 in connection with computer 900 is convenient. Optionally, further carriers and further signals embody computer program products (CPP) to be executed by further processors in computers 901 and 902.

Input device 940 provides data and instructions for processing by computer 900. Device 940 can be a keyboard, a pointing device (e.g., mouse, trackball, cursor direction keys), microphone, joystick, game pad, scanner, or disc drive. Although the examples are devices with human interaction, device 940 can also be a device without human interaction, for example, a wireless receiver (e.g., with satellite dish or terrestrial antenna), a sensor (e.g., a thermometer), a counter (e.g., a goods counter in a factory). Input device 940 can serve to read carrier 970.

Output device 950 presents instructions and data that have been processed. For example, this can be a monitor or a display, (cathode ray tube (CRT), flat panel display, liquid crystal display (LCD), etc.), speaker, printer, plotter, vibration alert device and the like. Output device 950 can communicate with the user, but it can also communicate with further computers.

Input device 940 and output device 950 can be combined to a single device. Further, device 940 and/or 950 can be provided optionally.

Bus 930 and network 990 provide logical and physical connections by conveying instruction and data signals. While connections inside computer 900 are conveniently referred to as “bus 930”, connections between computers 900-902 are referred to as “network 990”. Optionally, network 990 includes gateways which are computers that specialize in data transmission and protocol conversion.

Devices 940 and 950 are coupled to computer 900 by bus 930 (as illustrated) or by network 990 (optional). While the signals inside computer 900 are mostly electrical signals, the signals in network are electrical, electromagnetic, optical or wireless (radio) signals.

Networks are commonplace in offices, enterprise-wide computer networks, intranets and the Internet (e.g., World Wide Web (“WWW”)). Network 990 can be a wired or a wireless network. To name a few network implementations, network 990 can be, for example, a local area network (LAN), a wide area network (WAN), a public switched telephone network (PSTN); a Integrated Services Digital Network (ISDN), an infra-red (IR) link, a radio link, like Universal Mobile Telecommunications System (UMTS), Global System for Mobile Communication (GSM), Code Division Multiple Access (CDMA), or satellite link.

A variety of transmission protocols, data formats and conventions is known, for example, as transmission control protocol/internet protocol (TCP/IP), hypertext transfer protocol (HTTP), secure HTTP, wireless application protocol (WAP), unique resource locator (URL), a unique resource identifier (URI), hypertext markup language (HTML), extensible markup language (XML), extensible hypertext markup language (XHTML), wireless markup language (WML), Standard Generalized Markup Language (SGML).

Interfaces coupled between the elements are also well known in the art. For simplicity, interfaces are not illustrated. An interface can be, for example, a serial port interface, a parallel port interface, a game port, a universal serial bus (USB) interface, an internal or external modem, a video adapter, or a sound card.

Computer and program are closely related. As used hereinafter, phrases, such as “the computer provides” and “the program provides” are convenient abbreviation to express actions by a computer that is controlled by a program.

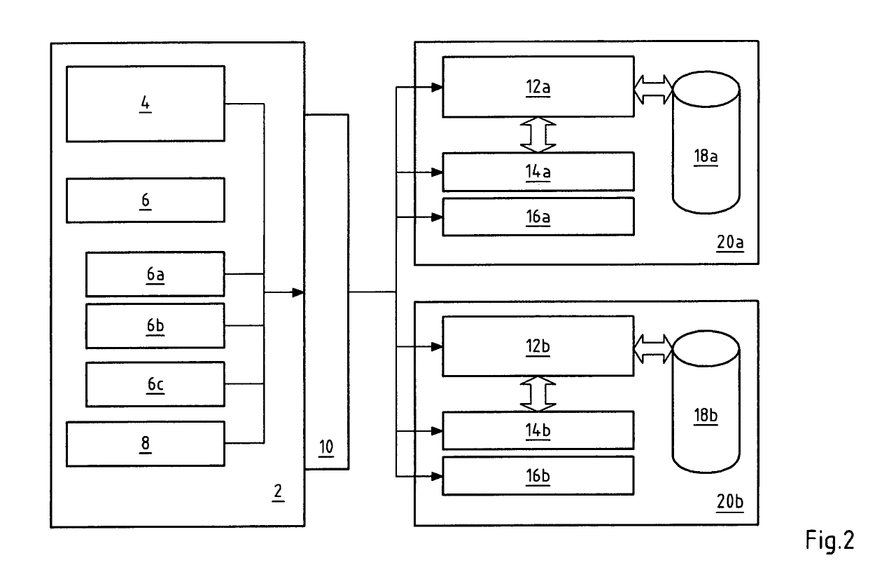

FIG. 2 depicts an exemplary system, according to an embodiment of the invention. Depicted is an administration computer 2 and one or more service computers 20a, 20b (collectively “20”).

The administration computer 2 may be a SAP R/3 server with an EH&S service running. The administration computer 2 may comprise a service administration program 4, a Word for Windows integrator dispatcher 6, one or more Word for Windows Integrator programs 6a-c, and a Word for Windows Integrator for WebGUI program 8.

The Word for Windows dispatcher 6, Word for Windows Integrator programs 6a-c, and Word for Windows Integrator for WebGUI program 8 may work according to the SAP EH&S program. They communicate with services running on local computers 20. Each of these local computers 20 may comprise Word for Windows Integrator services 14 and EXPERT services 16, which may communicate with the Word for Windows Integrator programs 6a-c to allow working according to the EH&S program.

Further depicted in FIG. 2 is a remote function call gateway 10, service management programs 12 and databases 18.

The services 14, 16 may be installed on the service computers 20, locally. For each service 14,16, a registry entry defines the service parameters. The service parameters may be used to administrate the services. The registry entries are stored in the databases 18. The databases 18 may store, for example, wwi.ini, saprfc.ini, temp files, event log files, rules, and/or registry files. As the services are installed locally, the administration has to be carried out locally or a central administration program 4 provides this functionality.

For centrally administrating the respective services, a remote function call gateway 10 provides a single interface for exchanging remote function call messages, which might be extended by new messages used for administration reasons.

The services 14,16 run as Windows services. For administrating theses services 14,16, a service management program 12 may also be locally installed on each computer, respectively. On each computer 20, only one service management program 12 may be installed. The service management program 12 is also installed as a Windows service and may be configured to start automatically after booting the operating system of the computer 20.

After booting and starting the service management program 12, this service management program 12 may register at the service administration program 4 using a remote function call messages and provide a unique program ID. The program ID is transmitted from the service management program 12 to the service administration program 4 via the remote function call gateway 10, providing a single interface for communication.

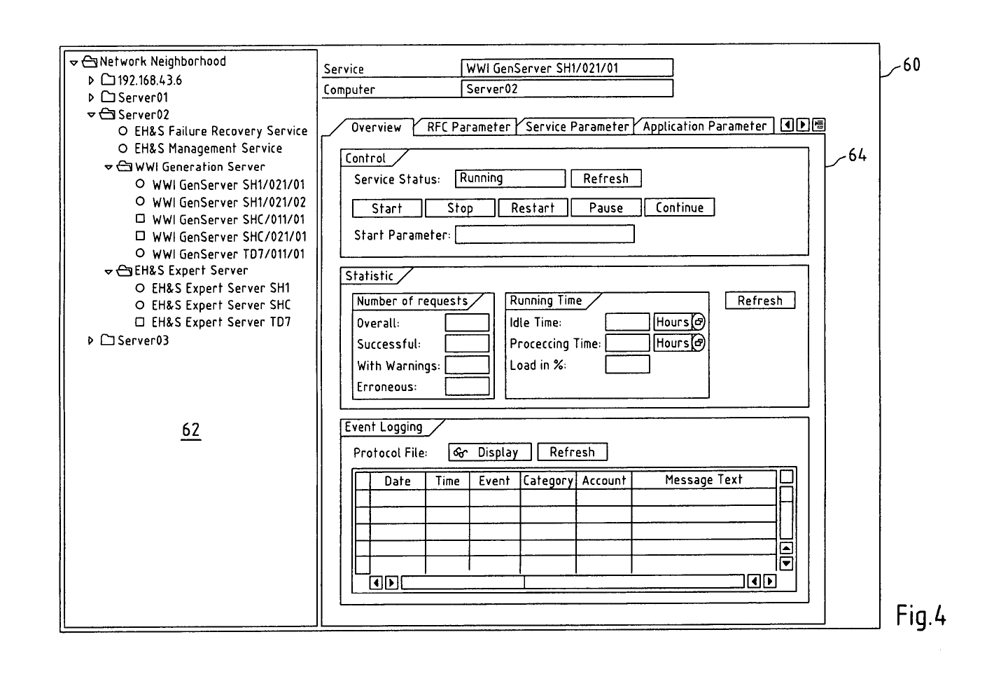

It can be seen from FIG. 2 that more than one service management program 12 may register at the service administration program 4. The service administration program 4 provides administration of the respective service via a graphical user interface, examples of which are depicted and described below with reference to FIGS. 4-7.

In one embodiment, the service management program 12 transmits service control messages, service configuration messages, and service statistic messages to the service administration program 4 via the remote function gateway 10 using remote function call messages. According to user selections in the graphical user interface provided by the service administration program 4, service configuration parameters are transmitted to the respective service management program 12 via the remote function call gateway 10. Within the service management program 12, the service configuration parameters are used for configuring the respective services. This may be done by editing the registry entries of the services.

To identify the local services 14,16 within the graphical user interface and to allow configuration of the services centrally, the service management program 12 transmits a list of locally available services to the service administration program 4 via the remote function call gateway 10. This list may allow for selecting a single service, acquiring the service configuration parameters and log file entries of this service centrally. It may further allow for editing the service configuration centrally and communicating the edited service configuration of the respective service.

To allow the configuration of the registry files and the services locally, the service management programs 12 may have local administration rights or the user account, under which the service management program 12 was installed on, is assigned administration rights.

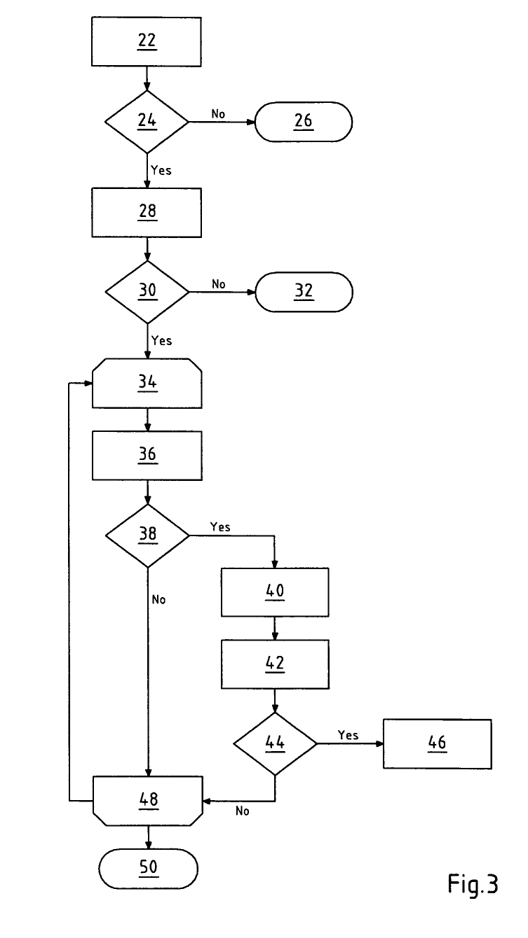

FIG. 3 depicts a flowchart of an exemplary method that shows the acquisition of the program IDs for the service management programs 12 registered at the service administration program 4.

In step 22, all program IDs of all remote servers, which have registered at the gateway 10 are acquired. After that in step 24 it is checked, whether any servers are registered at the gateway 10. In case no programs are registered, an error message may be produced in step 26.

In step 28, the destination paths for the service management program corresponding to the program IDs are read from a database.

After the destination paths are read from the database, they are checked at step 30. This analysis may include checking whether the respective path is available and accessible. In case the path is invalid, an error message may be produced in step 32.

In step 34, each registered program ID is iteratively checked. First of all, in step 36, the respective program ID is checked and the destination of this program ID is acquired. In step 38, it is checked whether a destination for this program ID exists in the database. If yes, then in step 40 a list of exported functions of the actual destination is acquired by a remote function call to this destination and the availability of a certain function identifying a service management program is checked in step 42. In step 44, it is checked if the function is available. If yes, the function is executed in step 46 and the destination is registered as service management program 12 at the service administration program 4. In step 48 the iteration jumps back to step 34 if further program IDs are to be checked, and if all program IDs are checked, the iteration is stopped in step 50.

FIG. 4 depicts a screenshot 60 of an exemplary graphical user interface, consistent with an embodiment of the invention. The graphical user interface may be generated and presented to a user by the service administration program 4. On the left side of the screen 62, a list of all registered service management programs (e.g., SERVER01, SERVER02, etc) is presented. For each service management program the available services to be administrated are presented. The user may select one of the available services and may see all service parameters and service functionality on the right hand 64 of the screen.

On the top of the screen of the example of FIG. 4, the service computer and the selected service is shown. Below, the user may select between, for example, an overview, RFC parameters, service parameters and application parameters.

The overview, as depicted in FIG. 4, shows service control parameters. These show the present status of the service, which may be refreshed by pressing a button. The service may be started, stopped, restarted, paused or continued by pressing the respective button. Also, start parameters may be given.

Below, service statistics are presented to the user. These statistics may be been sent from the service management program 12 to the service administration program 4 via the single remote function call gateway 10. The statistics comprise a number of service requests, and service running time. The statistics allow calculating the workload of the respective service.

Further, an event log file is presented in FIG. 4. This log file may comprise all service control messages and other protocol messages specific to each service. The respective protocol messages may be presented to the user according to their category.

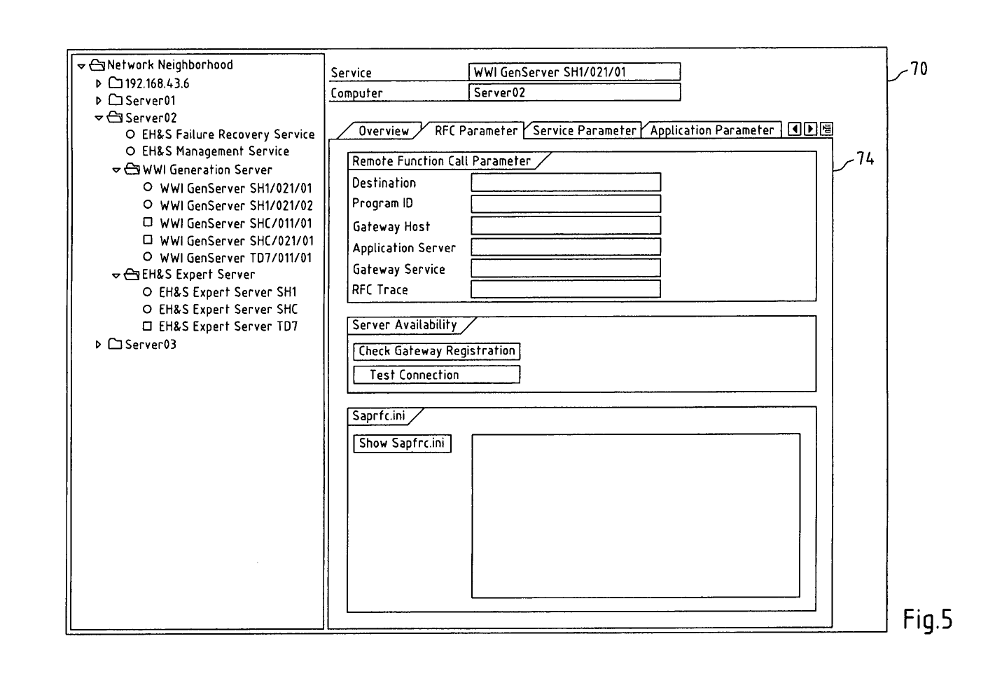

FIG. 5 depicts a second screenshot 70 of an exemplary graphical user interface. The screenshot is similar to the one depicted in FIG. 4.

As shown in the example of FIG. 5, the right side 74 of the screen shows RFC parameter information. First, a list of basic RFC function parameters is shown. From this information, it can be seen to and from which server RFC messages may be sent, and which program ID the respective service management program has.

Below, the availability of the service management program on the respective computer may be checked. Also, the connection with this computer may be checked.

Finally, as illustrated in FIG. 5, the RFC message configuration on the local computer may be presented and edited. The edited file may be sent to the local computer.

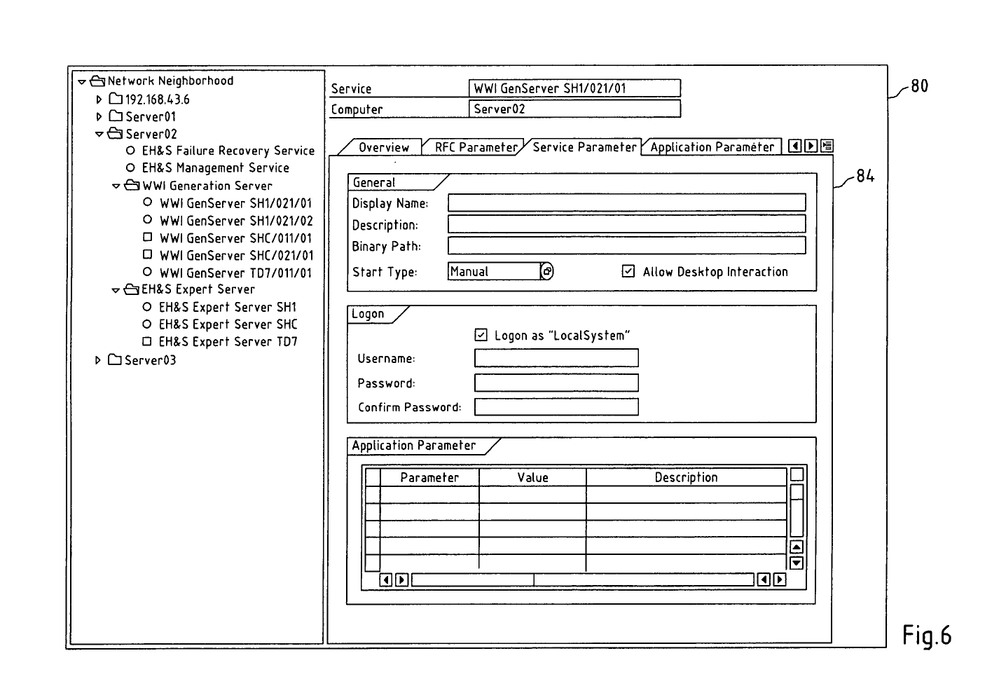

FIG. 6 depicts another screenshot 80 of an exemplary graphical user interface, showing the screen when the information about service parameters is selected. On the right side of the screen 84, service parameter information, such as the service name, its description, its path, and its start type, is presented.

Below, login information may be presented. This might be useful if the local service management program does not have administration rights per se. In this case, the service management program may be provided with a user name and a password to attain administration rights on the local computer. Also, application parameters are presented.

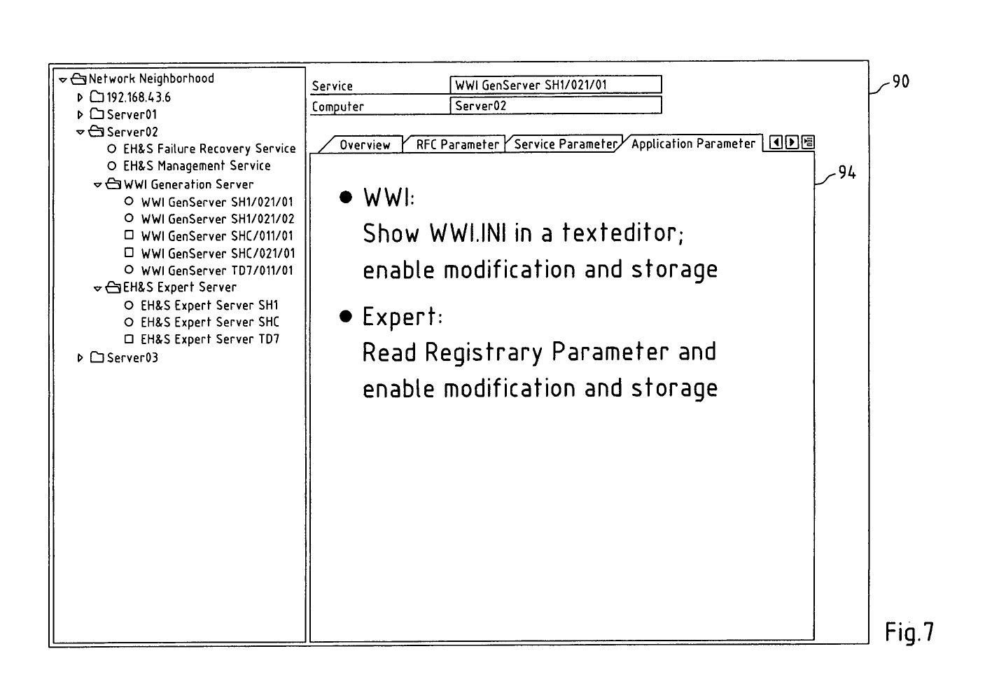

FIG. 7 depicts an exemplary screenshot 90 showing service parameters. On the right side 94 of the exemplary graphical user interface, service parameters of the locally installed services may be presented and edited. The local registry entries and further service parameters are shown to the user. The user may edit these files and the edited files are sent to the local service management program, where the respective parameters are edited and thus the service administrated.

Other embodiments of the invention will be apparent to those skilled in the art from consideration of the specification and practice of the embodiments of the invention disclosed herein. It is intended that the specification and examples be considered as exemplary only, with a true scope and spirit of the invention being indicated by the following claims.

1. A method for externally administrating local services with at least one centrally installed service administration program, said services being installed on one or more computers, the method comprising:
installing a service management program which administrates said services locally on said computers, respectively;
communicating, with said service administration program, administration information to said service management program in order to administrate said services, respectively; and
providing, through said service administration program, a single graphical user interface to administrate said local services through said service management program.

2. The method of claim 1, wherein said service administration program communicates with said service management program by transmitting remote function call messages through a single communication gateway.

3. The method of claim 2, wherein said service management program registers at said communication gateway using a program ID and said service management program is identified within said single graphical display and said service administration program using said program ID.

4. The method of claim 2, wherein said single communication gateway provides communication with said service management program for a plurality of service administration programs connected with said communication gateway.

5. The method of claim 2, wherein said single communication gateway provides access to a plurality of service management programs, respectively, from one service administrating program and one graphical user interface.

6. The method of claim 1, further comprising running said service management program in multiple threads, each thread communicating with a different service administration program through said remote function calls.

7. The method of claim 6, wherein for each service administration program an identifier is stored within the computer running the service management program, said identifier comprising service administration program destinations retrieved by remote function call parameters from the service administration program, and said service management program creating for each service administration program a new thread, respectively.

8. The method of claim 6, wherein said service management threads are synchronized so that messages from different service administration programs do not interfere during administration of said services.

9. The method of claim 1, further comprising providing, with said service management program, a list of services installed on said local computers to said service administration program and administering said service through said single graphical user interface.

10. The method of claim 1, further comprising sending, with said service administration program, messages to said service management program to install and/or de-install said services locally.

11. The method of claim 1, further comprising sending, with said service administration program, messages to said service management programs to start and/or stop said services locally.

12. The method of claim 1, further comprising sending, with said service management program, service control messages comprising service control information of said services to said service administration program and presenting, with said service administration program, said service control information through said single graphical user interface.

13. The method of claim 12, further comprising dividing said service control information is divided into a plurality of categories, including at least one of service status information, service warning information and service error information, and presenting said service control information through said single graphical user interface in a different way according to its category.

14. The method of claim 1, further comprising sending, with said service management program, service configuration parameter messages comprising configuration parameters of said services to said service administration program, and presenting said configuration parameters through said single graphical user interface.

15. The method of claim 14, further comprising storing, with said service administration program, said configuration parameters and enabling editing said services with said configuration parameters through said single graphical user interface.

16. The method of claim 1, further comprising sending, with said service management program, service statistic messages comprising statistics of said services to said service administration program, and presenting said statistics through said single graphical user interface.

17. The method of claim 16, wherein said statistics comprise information about at least one a number of accesses to said services, operating hours of said services, and idle times of said services.

18. The method of claim 1, further comprising providing said service management program with local administration rights for local service administration.

19. The method of claim 1, further comprising acquiring, during installing said service management program locally, a local operation account of said service management program, said local operating account being provided with administration rights for local service administration.

20. A computer system comprising a central administration computer and a local service computer operating services locally,
said local computer comprising service operating means for operating said services and service management means for operating a service management to administrate said services locally,
said central computer comprising service administration means for operating said service administration and communication means for communicating administration information with said service means to administrate said services, and
said central computer further comprising display means for displaying a single graphical user interface to administrate said services locally through said service management means.

21. The computer system of claim 20, further comprising a single communication gateway for sending remote function call messages between said service administration means to said service management means.

22. The computer system of claim 21, further comprising registration means for registering said service management means at said communication gateway using a program ID, said service administration means administrating said service management means through said single graphical display using said program ID.

23. The computer system of claim 21, wherein said single communication gateway enables communication with said service management means for a plurality of service administration means connected with said communication gateway.

24. The computer system of claim 21, wherein said local service computer provides a multi thread environment for running said service management means with multiple threads, each thread communicating with a different service administration means through said remote function calls.

25. The computer system of claim 21, wherein said service management computer further comprises storage means for storing remote function call parameters from said service administration means.

26. The computer system of claim 25, wherein the computer system comprises a plurality of local service computers, each of said local service computers comprising synchronizing means to synchronize said threads so that messages do not interfere with one another during administration of said services.

27. The computer system of claim 20, wherein said service management means provides a program ID to said service administration means.

28. The computer system of claim 20, wherein said service management means comprises a list of services installed on said local computer, and wherein said service management means transmits said list via a remote function call.

29. A computer program product for externally administrating local services, such as Windows-based services, with at least one centrally installed service administration program, the computer program product comprising a computer program with instructions operable to cause a processor to:
install said services on one or more computers;
administrate said services locally with a service management program installed on said computers, respectively;
communicate administration information between said service administration program and said service management program to administrate said services, respectively; and
provide a single graphical user interface to administrate said local services through said service management program graphically.

30. The computer program product of claim 29, wherein said service administration program communicates with said service management program by transmitting remote function call messages through a single communication gateway.

31. The computer program product of claim 30, wherein said service management program registers at said communication gateway using a program ID and said service management program is identified within said single graphical display and said service administration program using said program ID.

32. The computer program product of claim 30, wherein said single communication gateway provides communication with said service management program for a plurality of service administration programs connected with said communication gateway.

33. The computer program product of claim 30, wherein said single communication gateway provides access to a plurality of service management programs, respectively, from one service administrating program and one graphical user interface.

34. The computer program product of claim 29, wherein said service management program runs in multiple threads, each thread communicating with a different service administration program through remote function calls.

35. The computer program product of claim 34, wherein for each service administration program, an identifier is stored within the computer running said service management program, said identifier comprising service administration program destinations retrieved by remote function call parameters from the service administration program, and said service management programs create for each service administration program a new thread, respectively.

36. The computer program product of claim 34, wherein said service management threads are synchronized so that messages from different service administration programs do not interfere during administration of said services.

37. The computer program product of claim 29, wherein said service management program provides a list of services installed on said local computers to said service administration program and said services are presented and administrated through said single graphical user interface.

38. The computer program product of claim 29, wherein said service administration program sends messages to said service management program to install and/or de-install said services locally.

39. The computer program product of claim 29, wherein said service administration program sends messages to said service management programs to start and/or stop said services locally.

40. The computer program product of claim 29, wherein said service management program sends service control messages comprising service control information of said services to said service administration program, and said service administration program presents said service control information through said single graphical user interface.

41. The computer program product of claim 40, wherein said service control information is divided into a plurality of categories including at least one of service status information, service warning information and/or service error information, and said service control information is presented through said single graphical user interface in a different way according to its category.

42. The computer program product of claim 29, wherein said service management program sends service configuration parameter messages comprising configuration parameters of said services to said service administration program, and said service administration program presents said configuration parameters through said single graphical user interface.

43. The computer program product of claim 42, wherein said service administration program stores said configuration parameters and enables editing said services with said configuration parameters through said single graphical user interface.

44. The computer program product of claim 29, wherein said service management program sends service statistic messages comprising statistics of said services to said service administration program, and said service administration program presents said statistics through said single graphical user interface.

45. The computer program product of claim 44, wherein said statistics comprise information about a number of accesses to said services, operating hours of said services, and idle times of said services.

46. The computer program product of claim 29, wherein said service management program is provided with local administration rights for local service administration.

47. The computer program product of claim 29, wherein during installing said service management program locally, a local operation account of said service management program is acquired and said local operating account is provided with administration rights for local service administration.

48. A display for external administration of local services, such as Windows-based services, through at least one centrally installed service administration program, the display showing administration information to administrate local services through service management programs installed on one or more local computers, said service administration program communicating administration information with said service management program to administrate said services, respectively.

49. The display of claim 48, wherein a list of services installed on said local computers is provided from at least one of said service management programs to said service administration program for administrating services.

50. The display of claim 48, wherein the display includes service control messages comprising service control information of said services sent from at least one of said service management programs to said service administration program.

51. The display of claim 48, wherein the display shows said service control information divided into the following categories:
service status information, service warning information and service error information, and
further wherein the display shows said service control information according to its category.

52. The display of claim 48, wherein the display shows service configuration parameters of said services sent from at least one of said service management programs to said service administration program.

53. The display of claim 48, wherein the display shows service statistics sent from at least one of said service management programs to said service administration program.
